(19) United States
(12) Patent Application Publication
(10) Pub. No.: US 2020/0175294 A1
(43) Pub. Date: Jun. 4, 2020

(54) CHARACTER DISPLAY SYSTEM, CHARACTER DISPLAY DEVICE, AND PROGRAM FOR IMPLEMENTING CHARACTER DISPLAY SYSTEM

(71) Applicant: SUNNET CO., LTD., Odawara-shi, Kanagawa (JP)

(72) Inventor: Satoshi ICHIKAWA, Odawara-shi, Kanagawa (JP)

(21) Appl. No.: 16/065,491

(22) PCT Filed: Apr. 2, 2018
(86) PCT No.: PCT/JP2018/014165

§ 371 Date: Jun. 22, 2018

(30) Foreign Application Priority Data
Oct. 24, 2017 (JP) 2017-205504

(51) Int. Cl. G06K 9/03; G09G 3/04; G06K 9/62

(52) U.S. Cl. CPC G06K 9/033; G06K 2209/01; G06K 9/6201; G09G 3/045

(57) ABSTRACT

An object of the present invention is to provide a character display system that allows a verification operator to adjust a work screen for verification to a display method with ease of work for oneself. The problem is solved by providing a display format determining device. In the presence of adjusted display information obtained by adjustment such that the characters of character image data and the characters of recognized character data with the characters being displayed to be aligned with each other are arranged to facilitate comparison between the characters by a verification operator, the display format determining device decides that the recognized character data information is displayed based on the adjusted display information, and in the absence of the adjusted display information, the display format determining device decides that the recognized character data information is displayed based on initial display information determined in advance according to a verification target.

### TECHNICAL FIELD

The present invention relates to a character display system, a character display device, and a character display program that are used for data entry.

### BACKGROUND ART

In a large volume of commercially available documents containing characters not converted into text data (characters of analog data), the characters need to be converted into text data in recording and processing of character information. Thus, service for correctly converting character information of analog data into text data has been commercially established as “key puncher” in the past and currently as “data entry”.

In recent years, methods using OCR (optical character recognition) devices have been widely used for data entry. In such a method using an OCR device, an operator visually verifies whether analog data has been correctly converted into text data. In other words, the verification operator visually compares text data obtained by the OCR device with image data containing the characters of the same target documents. If the text data is different from the image data, the text data was confirmed to be erroneous and thus errors are corrected.

Data other than handwritten characters can be correctly converted into text data by the OCR device with a high probability of 90% or higher. Thus, there are only a few errors to be corrected by the verification operator. This leads to data entry with high operation efficiency, so that the data entry of relatively high quality can be provided. However, the verification operator looks at the overall target documents during the verification, which may cause leakage of information.

As a method for eliminating the risk of leakage of information, the data entry targets of invoices or the like may be divided into items (Non Patent Literature 1, Non Patent Literature 2). In this case, “items” mean entry target items including a name, a date of birth, an individual number, a product name, and a product number. Segments of data are classified into the items, and the verification operator is caused to work each of the items without being informed of item types. According to this method, the verification operator does not look at the overall target documents of data entry, thereby eliminating the risk of leakage of information. Furthermore, the verification operator only verifies a list of numbers with the same number of digits, achieving high operation efficiency.

Another device provides visual comparison between text data obtained by an OCR device with image data obtained from the same target of verification, easily creating an input screen format (Non Patent Literature 3). This device can arrange the text data and the image data in vertical and horizontal directions. Moreover, a color image can be freely selected.

A shortage of verification operators has become a serious problem. Even if OCR techniques develop, it is important to match text data to analog data in data entry service. Thus, the need for visual inspections by operators is hardly eliminated in the current techniques. This requires the provision of efficient verification systems that allow effective use of small human resources.

Since verification operators vary in the level of experience and capability, the targets of verification are classified in terms of the difficulty levels of works. This allows an experienced operator and a skilled operator to conduct works of high difficulty levels and allows an inexperienced operator and an unskilled operator to conduct works of low difficulty levels, thereby achieving high efficiency.

When the verification operator visually compares text data obtained by an OCR device with image data obtained from the characters of the same target document, the text data and the image data are desirably analogous to each other in terms of character vertical positions, character horizontal positions, character sizes, character spacings, and fonts. The verification operator desirably verifies matches of a set of data in a minimum time, and thus it is quite easy to find a difference between the text data and the image data that are analogous to each other in the above points.

Another technique is available in which a data entry provider registers a plurality of verification operators as operators for data entry under contract from clients. The verification operators access the site of the provider via the Internet and conduct data entry. For example, the data entry provider notifies the registered verification operators of works to be conducted, and then the verification operators having received the notification verify the works in a predetermined time limit. At this point, the verification operators who work on their PCs may turn on the PCs to conduct the works, turn off the PCs to suspend the works, and then turn on the PCs again after a while to restart the works. Also in this case, it is highly desirable that text data and image data are efficiently analogous to each other in terms of character vertical positions, character horizontal positions, character sizes, character spacings, and fonts.

### CITATION LIST

### Non Patent Literature

[Non Patent Literature 1]
A web site of FUJITSU LIMITED, Entry Function, [Retrieved on Jul. 7, 2017] on the Internet [http://www.fujitsu.com/jp/services/business/business-process-outsourcing/infra/entry/]
[Non Patent Literature 2]
A web site of NISSHO ELECTRONICS CORPORATION, e-Entry Express+, [Retrieved on Jul. 23, 2017] on the Internet [https://www.nissho-ele.co.jp/product/3e_plus/function.html]
[Non Patent Literature 3]
A web site of SEC Corporation Ltd., Super-Entry 7, [Retrieved on Sep. 19, 2017] on the Internet [https://www.sec-inf.co.jp/product/super-entry?-8/]

### SUMMARY OF INVENTION

### Technical Problem

An object of the present invention is to provide a character display system configured such that when a verification operator visually compares text data obtained by an OCR device with image data obtained from the characters of the same target document with the text data and the image data being displayed to be aligned with each other, the text data and the image data are adjusted so as to be easily compared with each other by the verification operator in terms of character vertical positions, character horizontal positions, character sizes, character spacings, and fonts, achieving ease of work.

Another object of the present invention is to provide a character display system in which a verification operator can adjust a work screen for verification according to a display method with ease of work, and after the adjustment, the operation screen adjusted by the operator is displayed even when a work is suspended and restarted.

Another object of the present invention is to provide a character display system that can classify the targets of verification according to the levels of difficulty and allocate works according to the skills of verification operators who vary in the level of experience and skill.

### Solution to Problem

In an invention according to claim 1, the problems are solved by a character display system including: character display means for character image data, the character display means displaying character image data information acquired from a verification target; and character display means for recognized character data, the character display means displaying recognized character data information acquired from the verification target, the character display system being used for a character input system in which a character of the character image data and a character of the recognized character data are compared with each other and the characters are verified when the characters matches with each other, the characters being displayed to be aligned with each other, the character display system further including display format determining means related to displaying the recognized character data information, wherein in the presence of adjusted display information adjusted such that the character of the character image data and the character of the recognized character data with the characters being displayed to be aligned with each other are arranged to facilitate comparison between the characters by a verification operator, the display format determining means decides that the recognized character data information is displayed based on the adjusted display information, and in the absence of the adjusted display information, the display format determining means decides that the recognized character data information is displayed based on initial display information determined in advance according to the verification target.

In an invention according to claim 2, the problems are solved by the character display system according to claim 1, in which the latest adjusted display information is always stored as the adjusted display information.

In an invention according to claim 3, the problems are solved by the character display system according to claim 1 or 2, in which in terms of a character size, a character spacing, a character vertical position or a character horizontal position, the displayed character of the recognized character data is caused to be consistent with the character of the character image data to be adjusted such that the characters are arranged to be easily compared by the verification operator, the characters being displayed to be aligned with each other.

In an invention according to claim 4, the problems are solved by the character display system according to any one of claims 1 to 3, the character display system including verification target classifying means that classifies the verification target in terms of the level of difficulty in verification according to the attributes of the characters, wherein the verification operator is selected using the verification target classifying means.

In an invention according to claim 5, the problems are solved by the character display system according to claim 4, the character display system including verification operator classifying means in which the verification operator is classified in terms of the capability of verification, wherein the verification operator is selected by matching of the verification target classifying means and the verification operator classifying means.

In an invention according to claim 6, the problems are solved by a character display device including: character display means for character image data, the character display means displaying character image data information acquired from a verification target; and character display means for recognized character data, the character display means displaying recognized character data information acquired from the verification target, the character display device being used for a character input system in which a character of the character image data and a character of the recognized character data are compared with each other and the characters are verified when the characters match with each other, the characters being displayed to be aligned with each other, the character display system further including display format determining means related to displaying the recognized character data information, wherein in the presence of adjusted display information obtained by adjustment such that the character of the character image data and the character of the recognized character data with the characters being displayed to be aligned with each other are arranged to facilitate comparison between the characters by a verification operator, the display format determining means decides that the recognized character data information is displayed based on the adjusted display information, and in the absence of the adjusted display information, the display format determining means decides that the recognized character data information is displayed based on initial display information determined in advance according to the verification target.

In an invention according to claim 7, the problems are solved by a character display program that causes a computer to implement a display format determining function, the character display program including: character display means for character image data, the character display means displaying character image data information acquired from a verification target; and character display means for recognized character data, the character display means displaying recognized character data information acquired from the verification target, the character display program being used for a character input system in which a character of the character image data and a character of the recognized character data are compared with each other and the characters are verified when the characters matches with each other, the characters being displayed to be aligned with each other, the display format determining function being related to displaying the recognized character data information, wherein in the presence of adjusted display information obtained by adjustment such that the character of the character image data and the character of the recognized character data with the characters being displayed to be aligned with each other are arranged to facilitate comparison between the characters by a verification operator, the display format determining function decides that the recognized character data information is displayed based on the adjusted display information, and in the absence of the adjusted display information, the display format determining function decides that the recognized character data information is displayed based on initial display information determined in advance according to the verification target.

Moreover, the problems are solved by a character input system including character display means for character image data, the character display means displaying character image data information acquired from a verification target; and character display means for recognized character data, the character display means displaying recognized character data information acquired from the verification target, the character input system comparing the character of the character image data and the character of the recognized character data and verifies the characters when the characters match with each other, the characters being displayed to be aligned with each other, the character input system including verification target classifying means that classifies the verification target in terms of the level of difficulty in verification according to the attributes of the characters.

According to the system, the charge of verification work can be set according to the level of difficulty in verification. Moreover, the level of difficulty in verification is an objective scale for a verification time and thus can be used for scheduling.

Furthermore, the verification targets are classified by attributes, which means that the verification target is an error if the verification target contains attributes other than attributes to be verified are contained. Thus, when the characters of the character image data and the recognized character data displayed to be aligned with each other are compared and verified, a new criterion “characters with attributes other than attributes to be verified” can be added. Specifically, if the attribute to be verified is “number” and the recognized character data contains “Chinese character/kana”, it can be decided that the recognized character data has an error because of “Chinese character/kana”.

Moreover, the problems are solved by a character input system including character display means for character image data, the character display means displaying character image data information acquired from a verification target; and character display means for recognized character data, the character display means displaying recognized character data information acquired from the verification target, the character input system comparing the character of the character image data and the character of the recognized character data and verifies the characters, the characters being displayed to be aligned with each other when the characters match with each other, the character input system further including verification operator classifying means that classifies the verification operator in terms of the capability of verification, the verification operator being selected by matching of the verification target classifying means and the verification operator classifying means.

The characters of the image data and the characters of the recognized data may be displayed to be aligned with each other in the vertical or horizontal direction. In the case of a relatively large number of characters, two horizontal character strings may be replaced with two vertical character strings. In the case of a relatively small number of characters, two horizontal character strings may be replaced with one horizontal character string. The orientation can be optionally determined by a verification operator.

In a comparison between the characters of the image data and the characters of the recognized data, if the matching characters are verified, “matching characters” means “written characters of the same contents” but does not mean identical shapes and sizes. “Matching characters” means that the recognized character data is correctly digitized.

A phrase “the character of the character image data and the character of the recognized character data with the characters being displayed to be aligned with each other are arranged to facilitate comparison between the characters by a verification operator” means, for example, that character sizes, character spacings, and/or positions are consistent with each other. The degree of consistency for ease of viewing varies among operators.

The characters of the character image data and the recognized data displayed to be aligned with each other are adjusted so as to be easily compared with each other by the verification operator in terms of character fonts, character colors, and character background colors on a verification work screen.

The presence of adjusted display information means, for example, that adjusted information received from an operator's PC is stored in the display information storage device after administrator's hardware is adjusted. Since the adjusted information also includes information on the verification operator and information on the verification target, when the recognized character data is displayed for verification work, the presence or absence of adjusted information is decided with reference to the information on the verification operator and the verification target from the operator's PC.

Regarding recognized character data displayed on a work screen for the verification operator during verification work, the contents (character sizes, character spacings, right-aligned or left-aligned, horizontal positions, and vertical positions) are either of one assigned to verification targets according to the initial display rule and stored in the verification target storage device or one adjusted and stored in the display information storage device.

The recognized character data is displayed when information on the operator and information on the work target are transmitted from the operator's PC during verification work performed by the verification operator. When the recognized character data information is displayed on the PC of the verification operator, the administrator's hardware refers to the adjusted display information storage device of the administrator's hardware, examines the presence or absence of adjusted display information in the storage device corresponding to a required work target of the operator. In the presence of the display information, contents are displayed based on the adjusted display information, whereas in the absence of the information, contents based on information stored in the verification target storage device are displayed according to the verification target under the initial display rule.

Whether to provide the verification target with adjusted display information stored in the past can be decided by confirming the presence or absence of the adjusted display information in the adjusted display information storage device (e) of the storage device in terms of the verification target and the verification operator.

Regarding “character size”, “character spacing”, “character vertical positions”, and “character horizontal positions”, the verification operator visually decides whether the displayed characters of the recognized character data are consistent with the displayed characters of the character image data. Furthermore, “consistency” is exemplary, and the superordinate concept is that the characters of the image data and the recognized data are displayed to be aligned with each other so as to be compared easily with each other by the verification operator.

Moreover, the problems are solved by the character display system characterized in that the verification operator is selected by categorizing the verification targets in terms of the levels of difficulty in verification according to the attributes of characters.

The characters of the image data and the recognized data may be optionally displayed to be aligned with each other in the vertical or horizontal direction. The characters may be displayed in either direction easy to be compared depending on the number of characters of verification targets.

### Advantageous Effects of Invention

If the verification target includes the adjusted display information that is stored in the past, the characters of the recognized data are displayed in the adjusted display format. This allows the operator to perform verification work in any optional display format without readjustment.

When the verification operator visually compares the text data and the image data displayed to be aligned with each other, the text data and the image data are analogous to each other in terms of character vertical positions, character horizontal positions, character sizes, character spacings, and fonts. Thus, the verification operator can confirm mismatches between the text data and the image data in a short time, almost instantly.

The ease of work varies among verification operators. The operator can optionally adjust the display method, achieving ease of work. After the adjustment, the screen adjusted by the operator is displayed even if a work is suspended and restarted, achieving ease of work.

Since verification operators vary in the level of experience and capability, the verification targets are desirably classified in terms of character attributes according to the levels of difficulty and allocate works according to the skills of verification operators, achieving high efficiency.

### BRIEF DESCRIPTION OF DRAWINGS

FIG. 1 shows a hardware configuration of a display position determination device according to an embodiment of the present invention.

FIG. 2 shows a network configuration according to the embodiment of the present invention.

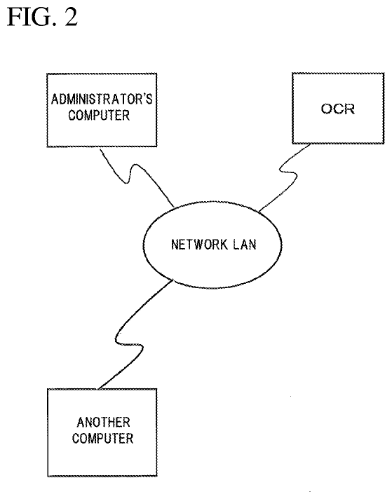

FIG. 3 shows examples of target documents according to the embodiment of the present invention.

FIG. 4 shows attribute rules for items and difficulty level codes according to the embodiment of the present invention.

FIG. 5 shows initial display rules for the respective items according to the embodiment of the present invention.

FIG. 6 shows processing on a verification target (f) according to the embodiment of the present invention.

FIG. 7 shows the selection of a verification operator for the verification target (g) according to the embodiment of the present invention.

FIG. 8 shows a work screen for the operator according to the embodiment of the present invention.

FIG. 9 shows the determination of the display format of recognized character data (h) according to the embodiment of the present invention.

FIG. 10 shows the adjustment of the display format (an example of horizontal positions) (i) according to the embodiment of the present invention.

FIG. 11 shows processing on adjusted display information (an example of horizontal positions) (i) according to the embodiment of the present invention.

### DESCRIPTION OF EMBODIMENT

A preferred embodiment of the present invention will be described below with reference to the accompanying drawings.

### First Embodiment

The meanings and contents of terms in the present specification will be described below.

“Target document” means a document containing verification targets. The target document may be any character document, e.g., an article purchase order, a list of customers, and a withholding slip.

“Verification target” means a target of verification. For example, if a target document is an article purchase order, verification targets include a trade name, an article number, the unit price of an article, an ordering quantity, and an order date on the purchase order.

“Character image data” means image data to be verified.

“Recognized character data” means character text data obtained by analysis and recognition of character data to be verified.

“Item” means an item to be verified. For example, “items” include a name, a date of birth, an individual number, a product name, a product number, a date of tax payment, the name of a tax payer, the individual number of a tax payer, the date of birth of a tax payer, an amount of tax payment, a trade name, an article number, the unit price, an ordering quantity, and an order date.

“Character attribute” means the type of character to be verified. For example, “character attributes” include character types such as “Chinese character/kana”, “alphabet/number/symbol”, and “number”.

“Character digit number” means the number of digits of characters to be verified. For example, “character digit number” of “2017 [symbol] 1 [symbol] 1 [symbol] (Jan. 1, 2017)” is “9”.

“Verification” means the confirmation of the contents of recognized character data.

“Verification operator” means an operator who enters data contents to be confirmed.

“Basic information to be verified” means information necessary for delivering articles to customers after the completion of verification work. The information includes a slip containing verification targets and clients of verification work.

“Clicking” means an operation for pressing down a button, e.g., a pointing device for moving a mouse cursor on a PC screen.

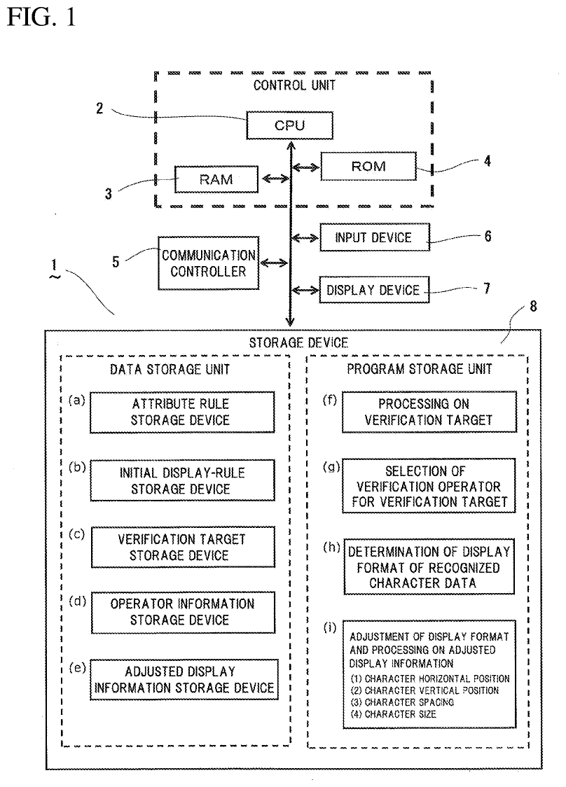

FIG. 1 shows a specific configuration of a display position determination device 1. The display position determination device includes various computer systems including a personal computer and a portable terminal.

As shown in FIG. 1, the display position determination device 1 includes a control unit for controlling the overall system. An input device 6, a display device 7, a storage device 8, a communication controller 5 and the like are connected to the control unit 11 via a bus line such as data bus. The control unit includes a CPU 2, a ROM 4, and a RAM 3.

In the display position determination device 1, an administrator's computer and another computer, e.g., the computer of a verification operator are connected to one another via a network or a LAN.

The display position determination device 1 may include a LAN server, the host of computer communications, and a computer system connected on the Internet as well as the computer systems. Moreover, functions may be distributed over the devices on the network, so that the overall network can constitute the display position determination device 1.

The storage device includes a program storage unit and a data storage unit.

The data storage unit includes:

(a) an attribute rule storage device;

(b) an initial display-rule storage device;

(c) a verification target storage device;

(d) an operator information storage device; and

(e) an adjusted display information storage device.

The program storage unit includes:

(f) a program for processing verification targets;

(g) a program for selecting a verification operator for the verification target;

(h) a program for determining a display format of recognized character data; and

(i) a program for adjusting the display format and processing adjusted display information.

(a) In the attribute rule storage device, a rule is stored such that the attributes of component characters are assumed for the respective items, so that each item is associated with one attribute.

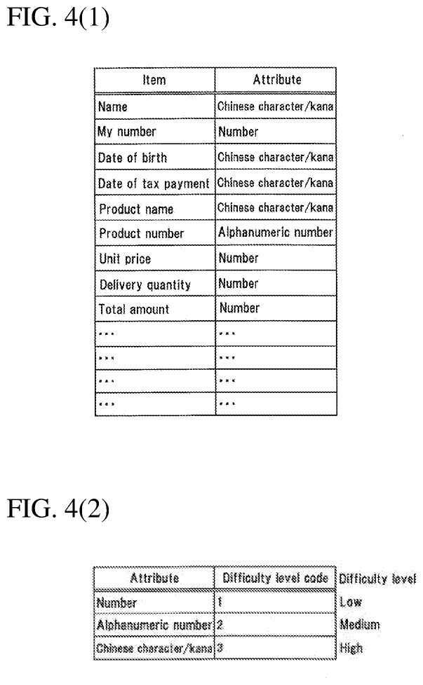

FIG. 4(1) shows the attribute rule. In this rule, the attributes are classified into “Chinese character/kana”, “alphanumeric character”, and “number”. For example, it is assumed that “name” includes Chinese characters or kanas, and thus “name” is associated with the attribute “Chinese character/kana”. Moreover, it is assumed that “product number” includes, for example, alphabets and numbers, and thus “product number” is associated with the attribute “alphanumeric character”. Furthermore, it is assumed that “individual number” includes, for example, only numbers, and thus “individual number” is associated with the attribute “number”. In this way, the items to be verified are associated with the respective attributes so as to establish the rule.

Moreover, the relationship between character attributes and the levels of difficulty in verification is determined as a rule. For example, the rule is established as shown in FIG. 4(2). Specifically, the larger the number of types of characters, the higher the level of difficulty in verification. Ten numbers from 0 to 9, 26 alphabets from A to Z, and several thousands of Chinese characters and kanas are available. Thus, it can be assumed that Chinese characters, alphanumeric characters, and numbers decrease in difficulty level in this order. Thus, difficulty level codes of 3(high), 2(medium), and 1(low) are assigned to Chinese characters, alphanumeric characters, and numbers in this order. The attribute rule is a combination of rules shown in FIGS. 4(1) and 4(2).

(b) In the initial display-rule storage device, a rule is described such that initial display rules are assumed for the respective items, so that each item is associated with one initial display rule.

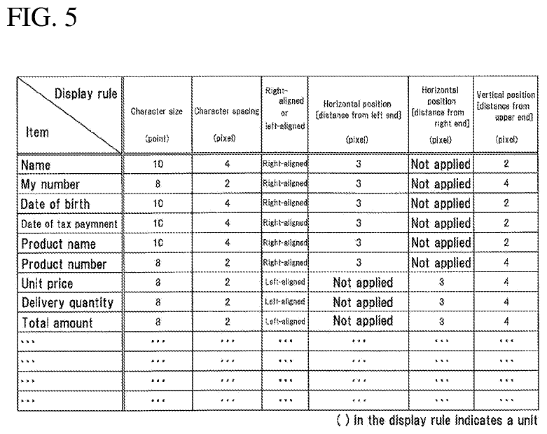

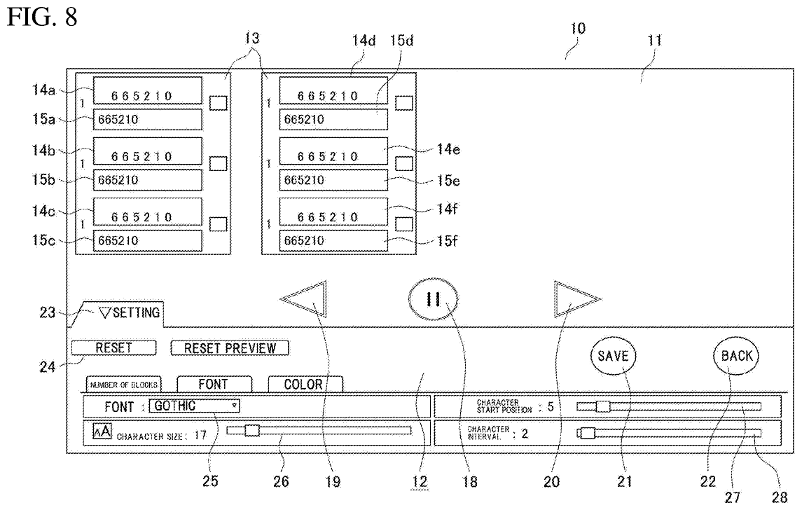

FIG. 5 shows examples of the initial display rules. This rule is used for initially displaying characters in recognized-data display boxes 15a to 15f (FIG. 8) of a recognized character data display box 13, which will be discussed later. The number of characters and a character size are assumed for each of the items and thus the rule provides assuming ease of viewing for an operator according to the assumed number of characters and the assumed character size. For example, the sizes and spacings of characters decrease with large number of characters. Moreover, the sizes, spacings, and vertical positions (a distance from the upper end) of characters increase with the characters with large number of stroke count.

The vertical display positions (a distance from the upper end) may be determined according to the size of character. Specifically, the smaller the character size, the larger the distance from the upper end. The larger the character size, the smaller the distance from the upper end. Regarding the vertical display positions, the vertical centers of characters may be set so as to always coincide with the vertical centers of the recognized character data display boxes 15a to 15f regardless of the character sizes.

Regarding horizontal display positions, it is necessary to first determine whether characters should be right-aligned or left-aligned according to the items. “Amounts” such as a unit price and a total amount and a delivery quantity are preferably right-aligned so as to facilitate comparison between two segments of data. Most of other items are preferably left-aligned so as to facilitate comparison. From this point of view, the rules are set to determine whether characters should be right-aligned or left-aligned in the respective items.

Then, regarding horizontal display positions (a distance from the left end or a distance from the right end), right-aligned characters are fixed at a distance from the right end regardless of a distance from the left side. Left-aligned characters are fixed at a distance from the left end regardless of a distance from the right side.

(c) Basic information, item information, character image data, recognized character data, associated attribute information, and associated initial display information on verification targets are stored in the verification target storage device.

The basic information on verification targets is information necessary for delivering verified data from a verification provider to a verification client or the like after the completion of verification. The basic information includes slips containing verification targets, verification clients and the like.

(d) In the operator information storage device, basic information on verification operators and information on the capability level codes of verification operators are stored for each of the verification operators.

The basic information on verification operators is information for specifying and evaluating the verification operators. The basic information includes the names, addresses, and work histories of the verification operators.

The capability level codes of the verification operators are codes classified into three: a capability level code 3, a capability level code 2, and a capability level code 1 in decreasing order of capability according to the capabilities of the verification operators.

(e) In the adjusted display information storage device, display information is stored with information on a verification operator in charge of a work, information on verification targets, and the date and time of the work. The display information is obtained after the work screen is adjusted to improve ease of work by the verification operator.

The display information obtained after the adjustment of the work screen is information on character horizontal positions, character vertical positions, character sizes, and character spacings that are relevant to the display of recognized character data after the adjustment. Specifically, regarding the character horizontal positions, distances from the left end of the recognized character data display box 15 (FIG. 8) are stored in units of pixels. Regarding the character vertical positions, distances from the upper end of the recognized character data display box are stored in units of pixels. Regarding the character sizes, the character sizes are stored as the number of points indicating the character sizes. Regarding the character spacings, the character spacings are each stored as a distance from the center of a character to the center of the adjacent character.

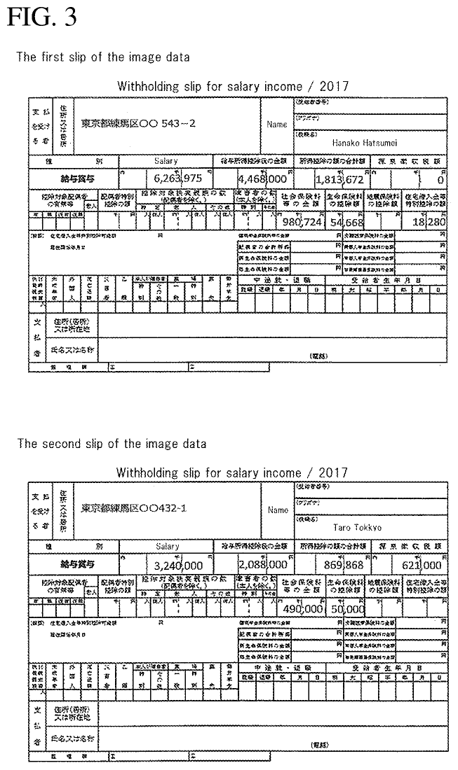

### [1. Processing on Verification Targets] (FIGS. 3, 4, 5, and 6)

FIG. 3 shows the image data of withholding slips as examples of target documents. Generally, a client of data entry requests a provider of data entry to enter several hundreds or several thousands of target documents. FIG. 3 shows the first and second slips of the target documents. The withholding slips contain items such as “address”, “name”, and various “amounts”. For example, 100 slips contain the different contents of 100 persons.

(i) The CPU 2 of an administrator's computer (hereinafter, “administrator's CPU”) stores verification targets in the verification target storage device by the attribute rules and the initial display rules according to the processing program of the verification targets (f). The processing program of the verification targets (f) will be discussed in (i) to (iv).

The basic information, the item information, the character image data, and the recognized character data on the verification targets are acquired. The basic information on the verification targets is information including slips containing the verification targets and the clients of verification. The basic information is necessary for delivery to the client or the like after the completion of the verification.

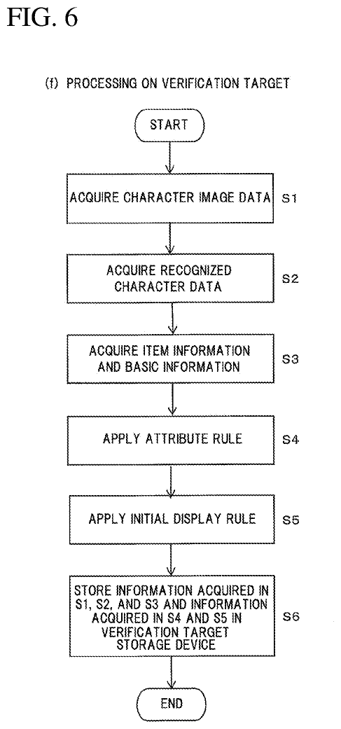

As indicated in steps 1 to 3 of FIG. 6, the administrator's CPU first acquires the character image data and the recognized character data from the verification targets (steps 1 and 2). In the present embodiment, an OCR device is used that can collectively acquire both of the data. Subsequently, the item information and the basic information on the verification targets are acquired (step 3). The item information and the basic information may be inputted through an input device, e.g., a keyboard.

(ii) The administrator's CPU applies the rules of the attribute rule storage device (a) of the data storage unit to the data (i) according to the item information on the verification targets.

As indicated by step 4 of FIG. 6, the attribute rules of the respective items are applied to the verification targets. In this case, the attributes for the respective items of the verification targets and the difficulty level codes of the attributes (FIG. 4) are applied according to the rules stored in the attribute rule storage device (a). The attributes including “Chinese character/kana”, “number”, and “alphanumeric character” are assigned to all the items according to an attribute assignment rule. The code number of difficulty level 3 is assigned to Chinese characters and kanas, the code number of difficulty level 2 is assigned to alphanumeric characters, and the code number of difficulty level 1 is assigned to numbers.

(iii) The administrator's CPU applies the rules of the initial display-rule storage device (b) of the data storage unit to the data (i) according to the item information on the verification targets.

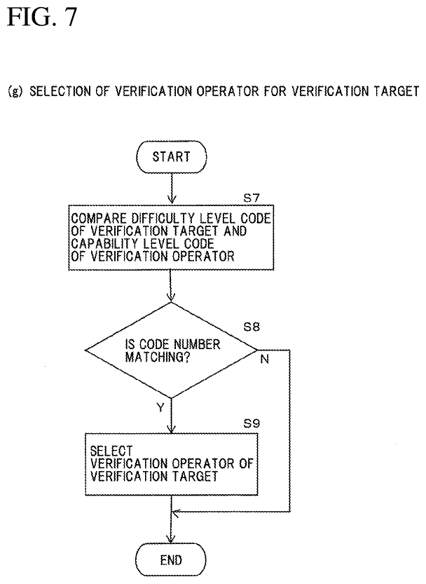

As indicated by step 5 of FIG. 6, the initial display rules for the respective items are applied to the verification targets. In this case, the initial display rules (FIG. 5) for the respective items of the verification targets are applied according to the rules stored in the initial display-rule storage device (b). The rules are rules to clearly display characters in the recognized character data display box 13 (FIG. 7), which will be described later.

(iv) In the verification target storage device (c) of the data storage unit, the administrator's CPU stores the basic information, the item information, the character image data, and the recognized character data on the verification targets, the attribute information obtained by applying the rules in (ii), and the initial display information obtained by applying the rules in (iii).

As indicated by step 6 of FIG. 6, the information acquired in step 1, step 2, and step 3 and the information acquired by applying the rules in step 4 and step 5 are stored in the verification target storage device.

Thus, the processing on the verification target is completed.

### [2. Verification Work by a Verification Operator (FIG. 8)]

The verification work by the verification operator will be sequentially described as follows: a. Access to administrator's data, b. Selection on a verification target selection screen, c. Verification start screen, d. Display format adjustment screen, and e. End. The display format adjustment screen of “d” is shown in FIG. 8 and other screens are omitted.

[a. Access to Administrator's Data]

When the verification operator turns on a PC to conduct a predetermined work, an access screen for verification work appears. The verification operator inputs his or her code number and password and thus is allowed to access administrator's data.

When the verification operator accesses the administrator's data, information including the code number of the verification operator, the date and time of access, and the time period of access is transmitted from the PC of the verification operator to the administrator's CPU, and then the information is recorded in the administrator's CPU.

[b. Selection on the Verification Target Selection Screen]

First, a screen showing a list of works appears. The list of works (work A, work B, work C, work D, . . . ) is provided as work targets for the verification operator by an administrator. A work target code number, an attribute, a deadline, and the number of targets are indicated for each of the works. In this case, information on verification targets and items is not disclosed. This prevents the verification operator from identifying the document types and items of the work targets. If some verification targets among all the targets have been already completed, the number of completed works is displayed.

The operator selects one to be conducted at that time (e.g., the work A) from the list of work targets.

[c. The Verification Start Screen of the Work A]

Then, the verification start screen of the work A appears. If the operator selects the work B in [b. Selection on the verification target selection screen], the verification start screen of the work B appears. The verification start screen of the work A has “setting”, “start”, and “exit” buttons. The selection of the “setting” button makes a shift to the display format adjustment screen (FIG. 8), the selection of the “start” button makes a shift to an input screen, and the selection of “exit screen” terminates the process of the work A and returns to the verification target selection screen of (b).

[d. Display Format Adjustment Screen (FIG. 8)]

An operation screen 10 includes a display screen 11 and a setting operation area 12. The display screen 11 includes character display areas 13. In the character display areas 13, pairs of character image data display boxes 14 and recognized character data display boxes 15 are vertically arranged in two columns. The operation screen 10 in FIG. 8 shows six pairs of the character image data display boxes 14 and the recognized character data display boxes 15. The number of pairs of the character image data display boxes 14 and the recognized character data display boxes 15 can be increased up to the size of the display screen 11 (as will be discussed later, the display screen 11 is extended by closing the setting operation area 12).

Characters to be verified are displayed in the character display areas 13 on the work screen of the verification operator. Character image data is displayed in character image data display boxes (14a to 14f) and recognized character data is displayed in the recognized character data display boxes (15a to 15f).

As will be discussed later, the recognized character data can be adjusted to be more usable for the operator. The adjusted data is stored, as will be discussed later, in the adjusted display information storage device along with the information on verification targets.

A “next” button 20 and a “back” button (during verification) 19 are used to select the process of a comparison between character image data and recognized character data. Specifically, upon a click on the “next” button 20, the comparison result is stored in the verification target storage device and data for a subsequent comparison is displayed. Upon a click on the “back” button (during verification) 19, the screen returns to the previous page without storing the comparison result in the verification target storage device.

A “pause” button 18 means a pause of comparison work and a pause of measurement of a working time. The setting operation area 12 includes font selecting means 25, character size selecting means 26, character start position selecting means 27, and character spacing selecting means 28. The verification operator operates the means so as to adjust the fonts, sizes, start positions, and spacings of characters to be verified.

The types of characters are selected from Gothic type and Mincho type for displayed characters on the font selecting means 25.

A character size is increased by moving the knob portion of the character size selecting means 26 to the right, whereas the character size is reduced by moving the knob portion to the left.

The start position of left-aligned characters is separated from the left end of the recognized character data display box 15 by moving the knob portion of the character start position selecting means 27 to the right, whereas the start position of left-aligned characters is brought close to the left end of the box by moving the knob portion to the left. In the case of right-aligned characters, the knob portion is moved in opposite ways.

A character spacing is increased by moving the knob portion in 28 to the right, whereas the character spacing is reduced by moving the knob portion to the left.

Upon a click on a “save” button 21, an adjustment result in the setting operation area 12 is stored.

Upon a click on a “back” button 22 (during the setting), the adjustment is paused without storing the intermediate result of the adjustment as adjusted display information and a state at the start of the adjustment is restored.

Upon a “setting operation area show/hide selection” button 23, the overall setting operation area 12 can be shown or hidden. The hiding of the setting operation area increases a space for displaying characters.

[e. Exit]

As described above, the “save” button means the termination of a work.

### [3. Selection of a Verification Operator for a Verification Target (FIG. 7)]

(v) By using the program for selecting a verification operator for a verification target (g), the administrator's CPU selects the verification operator so as to efficiently conduct a work according to the level of difficulty of the verification target.

The difficulty level code of the verification target stored in the verification target storage device (c) is compared with the capability level codes of the verification operators stored in the operator information storage device (d) (step 7), and the verification operator with a code number matching the difficulty level code is selected as an operator for the verification target (Yes in step 8). If there are no matches, the selection of the verification operator for the work target is terminated (No in step 8).

As described above, the capability level codes of the verification operators are assigned as the capability level code 3, the capability level code 2, and the capability level code 1 in decreasing order of capability according to the capabilities of the verification operators. The verification targets are also assigned with three codes: a difficulty level code 3, a difficulty level code 2, and a difficulty level code 1 in decreasing order of difficulty level according to the level of difficulty. Thus, works can be allocated such that a work target of high difficulty level is allocated to a verification operator of high capability level and a work target of low difficulty level is allocated to a verification operator of low capability level. The allocation allows the payment of monetary reward to the operators according to the difficulty levels of works. Moreover, if the verification target needs to be delivered to the client of the verification work by the deadline of delivery, the administrator can return a quick response as needed.

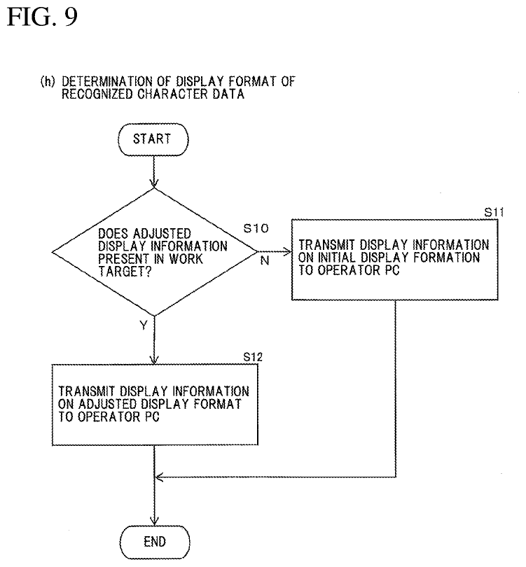

### [4. Display Format Determination of Recognized Character Data] (FIG. 9)

(vi) The administrator's CPU determines the display format of recognized character data by using the program for determining the display format of recognized character data (h), and indicates the format to an operator's CPU. The operator's CPU displays a work screen on an operator PC screen according to the indication from the administrator's CPU.

After the verification operator of the work target is selected, the administrator's CPU instructs the verification operator to conduct the work as specifically described in [2. Verification work by a verification operator] in the specification. For verification work, the verification target is displayed on the work screen of the operator. FIG. 8 illustrates an example of the work screen. The display formats of recognized character data on characters to be displayed on the work screen include an initial display format and an adjusted display format.

The initial display format is a display format acquired by applying the rule of the initial display-rule storage device (b) (FIG. 1) to the items of the verification targets. The initial display format is stored in the verification target storage device (c) (FIG. 1). When the verification operator first opens a verification target, the target is normally displayed in the initial display format on the work screen.

The adjusted display format is a display format adjusted by the verification operator so as to improve ease of work. The adjusted display format is stored in the adjusted display information storage device (e) (FIG. 1) along with information on the dates of changes. Which one of the initial display format and the adjusted display format is to be displayed is determined in the following steps:

The administrator's CPU examines whether work targets include the adjusted display information of the verification operator (step 10). If the work targets include the adjusted display information of the verification operator (Yes in step 10), the administrator's CPU transmits display information on the adjusted display format to the operator's PC (step 12).

If the work targets do not include the adjusted display information of the verification operator (No in step 10), the administrator's CPU transmits display information on the initial display format to the operator's PC (step 11).

Since the information on the verification operator in charge of the work, the information on the verification target, and the information on the date and time of the work are stored in the adjusted display information storage device, it can be decided whether the work targets include the adjusted display information of the verification operator. In this case, only “the presence or absence of the adjusted display information” is examined.

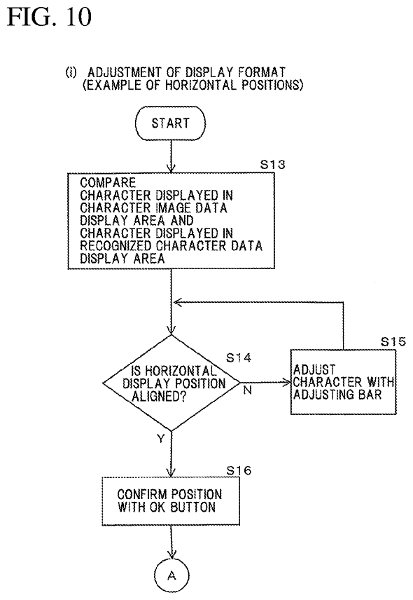

### [5. Adjustment of the Display Format (an Example of Horizontal Character Positions)] (FIGS. 8 and 10)

(vii) The administrator's CPU adjusts the layout of the characters of the character image data and the characters of the recognized character data displayed to be aligned with each other by using the program for adjusting the display format (i) such that the characters are easily compared with each other by the verification operator. Specifically, the verification operator compares characters displayed in the character image data display box and characters displayed in the recognized character data display box on the work screen. If the characters are located at different horizontal display positions, the positions are aligned with the character image data by an adjusting bar. The aligned positions are then confirmed.

The verification operator compares characters displayed in a character image data display area and characters displayed in a recognized character-data display area (step 13) and examines whether the characters are aligned or not (step 14). If the verification operator decides that the characters are located at proper positions (Yes in step 14), the positions are confirmed by an “OK” button (step 16). If the characters are not aligned (No in step 14), the adjusting bar is moved to adjust the characters to proper positions (step 15) and then the verification operator confirms the positions with the “OK” button (step 16).

It is important that the information on the verification operator in charge of the work, the information on the verification target, and the information on the date and time of the work are stored in the adjusted display information storage device.

FIG. 10 shows an example of the horizontal positions of characters. Character spacings, character sizes, and the vertical positions of characters are similarly adjusted by the adjusting bar and are confirmed by the “save” button.

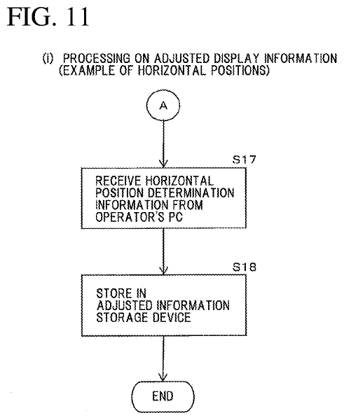

### [6. Processing of Adjusted Display Information (an Example of Character Horizontal Positions)] (FIGS. 8 and 11)

(viii) The administrator's CPU stores the adjusted display format in the adjusted information storage device by using the program for processing the adjusted display information (i). Specifically, the administrator's CPU receives information on the adjustment result from the operator's CPU and stores the information in the adjusted display information storage device.

A click on the “OK” button by the operator is transmitted to the administrator's CPU from the operator's PC. The administrator's CPU receives horizontal position determination information from the operator's PC (step 17) and stores the horizontal position determination information in the adjusted information storage measure. Information on a click on the “save” button is transmitted from the operator's PC to an administrator's PC along with the determined contents of information. Then, the administrator's CPU receives the information (step 17) and stores the information in the adjusted display information storage device (step 18).

### REFERENCE SIGNS LIST

1 display position determination device
2 CPU
3 RAM
4 ROM
5 communication controller
6 input device
7 display device
8 storage device
10 operation screen
11 display screen
12 setting operation area
13 character display area
14a to 14f character image data display box
15a to 15f recognized character data display box
18 “pause” button
19 “back” button (during verification)
20 “next” button
21 “save” button
22 “back” button (during setting)
23 “setting operation area show/hide selection” button
24a reset button
24b preview reset button
25 font selecting means
26 character size selecting means
27 character start position selecting means
28 character spacing selecting means

1. A character display system comprising:
character display means for character image data, the character display means displaying character image data information acquired from a verification target; and
character display means for recognized character data, the character display means displaying recognized character data information acquired from the verification target,
the character display system being used for a character input system in which a character of the character image data and a character of the recognized character data are compared with each other and the characters are verified when the characters matches with each other, the characters being displayed to be aligned with each other,
the character display system further comprising display format determining means related to displaying the recognized character data information,
wherein in presence of adjusted display information adjusted such that the character of the character image data and the character of the recognized character data with the characters being displayed to be aligned with each other are arranged to facilitate comparison between the characters by a verification operator, the display format determining means decides that the recognized character data information is displayed based on the adjusted display information, and
in absence of the adjusted display information, the display format determining means decides that the recognized character data information is displayed based on initial display information determined in advance according to the verification target.

2. The character display system according to claim 1, wherein latest adjusted display information is always stored as the adjusted display information.

3. The character display system according to claim 1, wherein in terms of a character size, a character spacing, a character vertical position or a character horizontal position, the displayed character of the recognized character data is caused to be consistent with the character of the character image data to be adjusted such that the characters are arranged to be easily compared by the verification operator, the characters being displayed to be aligned with each other.

4. The character display system according to claim 1, further comprising verification target classifying means that classifies the verification target in terms of a level of difficulty in verification according to attributes of the characters,
wherein the verification operator is selected using the verification target classifying means.

5. The character display system according to claim 4, further comprising verification operator classifying means in which the verification operator is classified in terms of capability of verification,
wherein the verification operator is selected by matching of the verification target classifying means and the verification operator classifying means.

6. A character display device comprising:
character display means for character image data, the character display means displaying character image data information acquired from a verification target; and
character display means for recognized character data, the character display means displaying recognized character data information acquired from the verification target,
the character display device being used for a character input system in which a character of the character image data and a character of the recognized character data are compared with each other and the characters are verified when the characters match with each other, the characters being displayed to be aligned with each other,
the character display device further comprising display format determining means related to displaying the recognized character data information,
wherein in presence of adjusted display information obtained by adjustment such that the character of the character image data and the character of the recognized character data with the characters being displayed to be aligned with each other are arranged to facilitate comparison between the characters by a verification operator, the display format determining means decides that the recognized character data information is displayed based on the adjusted display information, and
in absence of the adjusted display information, the display format determining means decides that the recognized character data information is displayed based on initial display information determined in advance according to the verification target.

7. A character display program that causes a computer to implement a display format determining function,
the character display program comprising:
character display means for character image data, the character display means displaying character image data information acquired from a verification target; and
character display means for recognized character data, the character display means displaying recognized character data information acquired from the verification target,
the character display program being used for a character input system in which a character of the character image data and a character of the recognized character data are compared with each other and the characters are verified when the characters matches with each other, the characters being displayed to be aligned with each other,
the display format determining function being related to displaying the recognized character data information,
wherein in presence of adjusted display information obtained by adjustment such that the character of the character image data and the character of the recognized character data with the characters being displayed to be aligned with each other are arranged to facilitate comparison between the characters by a verification operator, the display format determining function decides that the recognized character data information is displayed based on the adjusted display information, and
in absence of the adjusted display information, the display format determining function decides that the recognized character data information is displayed based on initial display information determined in advance according to the verification target.
